(19) United States
(12) Patent Application Publication
(10) Pub. No.: US 2025/0118507 A1
(43) Pub. Date: Apr. 10, 2025

(54) Switch, and mouse and keyboard using the same

(71) Applicant: DONGGUAN CITY KAIHUA ELECTRONICS CO., LTD, Dongguan, Guangdong (CN)

(72) Inventors: FuXi Wu, Dongguan, Guangdong (CN); Yijiang Xiao, Dongguan, Guangdong (CN)

(21) Appl. No.: 18/293,726

(22) PCT Filed: Aug. 4, 2022
(86) PCT No.: PCT/CN2022/110165

§ 371 Date: Jan. 30, 2024

(30) Foreign Application Priority Data
Aug. 17, 2021 (CN) 202121936027.3

(51) Int. Cl. H01H 13/14

(52) U.S. Cl. CPC H01H 13/14; H01H 2215/03

(57) ABSTRACT

The present utility model discloses a switch comprising a housing, a silent module arranged in the housing, and a guide core arranged in the housing above the silent module and extending from the housing. It has a simple structure and is easy to use, and can be applied to buttons of the mouse and the keyboard.

### TECHNICAL FIELD

The present utility model relates to the technical field of a key switch, and particularly relates to a switch, and a mouse and a keyboard using the same.

### BACKGROUND ART

The current silent key switch is mainly composed of an elastic sheet and a rubber pad, with the principle that the elastic sheet is pressed down and contacts with a middle contact point to achieve signal conduction. The elastic sheet used is an integrated structure with a middle upper arch part, and can still generate a slight dull sound when used. The main function of the rubber pad is to isolate the elastic sheet from the guide core, so that when the elastic sheet is reset upwards, the elastic sheet is directly hit on the rubber pad to further reduce the sound when the switch is pressed. However, the hand feeling from pressing is relatively poor. That is to say, the existing silent switch may not achieve the ideal silent effect and the hand feeling from pressing is poor.

### SUMMARY OF THE UTILITY MODEL

In view of the above-mentioned deficiencies, the object of the present utility model is to provide a switch which can achieve a near-silent effect when pressed and also has an excellent hand feeling and can be combined with a non-silent switch to form a non-silent and silent one-piece switch. By using an improved guide core in the one-piece switch and providing a switching piece on the improved guide core, the one-piece switch can be easily switched between non-silent and silent states. The structure is simple and easy to use, and can be applied to buttons of the mouse and the keyboard.

According to the technical solutions adopted by the utility model to achieve the above-mentioned purpose, a switch comprises a housing, a silent module arranged in the housing, and a guide core arranged in the housing above the silent module and extending from the housing. The silent module comprises a silencing elastic sheet arranged in the housing, and a silencing rubber pad arranged in the housing above the silencing elastic sheet; the silencing elastic sheet is upwardly arched at a central position thereof to form an upper arched portion; a through hole is formed on the upper arched portion; an action sheet is arranged on the silencing elastic sheet at the through hole; and the action sheet is connected to the silencing elastic sheet via at least one connecting arm.

As a further improvement of the present utility model, the silencing rubber pad comprises a middle limiting block, and a plurality of arc-shaped support sheets which are annularly arranged at a lower end of the middle limiting block and uniformly distributed, the support sheets having the same circle center and being located on the same cylindrical curved surface.

As a further improvement of the present utility model, a height of the action sheet is higher than a height of an upper end of the silencing elastic sheet; a lower action protrusion is arranged on a lower end surface of the middle limiting block and above the action sheet; the support sheet is arranged around the periphery of the lower action protrusion; the shape of the lower action protrusion is a cone frustum; the diameter of the lower end of the lower action protrusion is greater than the diameter of the upper end thereof; a first upper action protrusion is further formed on the upper end face of the middle limiting block; and the lower end of the support sheet is inclined outwardly and contacts an edge of the upper surface of the silencing elastic sheet.

As a further improvement of the present utility model, the housing comprises a base, and an upper cover arranged above the base; a first through hole is formed on the upper cover for the upper end of the guide core to extend from the housing; a cavity for accommodating the silent module is formed on the base; the silent module further comprises a contact bubble point module arranged in the cavity and located below the silencing elastic sheet, wherein the contact bubble point module comprises two side contact bubble points arranged in the cavity and located at both sides below the silencing elastic sheet, and a middle contact bubble point arranged in the cavity below the action sheet and located between the two side contact bubble points; and the lower surface of the silencing elastic sheet contacts with the two side contact bubble points.

As a further improvement of the present utility model, a non-silent module is arranged inside the housing and outside the cavity; the non-silent module includes a non-silent contact block formed on the base, a reed arranged on the base above the non-silent contact block, and a pressing piece movably arranged in the housing and above the reed.

As a further improvement of the present utility model, a first connecting post and a second connecting post are respectively formed inside the housing and outside the cavity; a first clamping groove is formed outside the first connecting post; a second clamping groove is formed outside the second connecting post; a first opening through which the first connecting post passes and a second opening through which the second connecting post passes are respectively formed on the reed; an inner wall of the first opening is clamped and connected to the first clamping groove; an elastic connecting arm bent downwards is formed on a side wall of the second opening; an end portion of the elastic connecting arm extends into the second opening and is formed with an opening cooperating with the second clamping groove, the opening being clamped and connected to the second clamping groove; a third opening is further provided on the reed and above the non-silent contact block; a non-silent action block is arranged on the third opening, the non-silent action block being made of a metal material; an annular groove is arranged on the outer periphery of the side face of the non-silent action block; the inner side wall of the third opening is clamped into the annular groove; the pressing piece comprises a transverse arm above which a second upper action projection is formed; and the lower end face of the transverse arm is bulged downwards to form a curved structure and acts on the reed.

As a further improvement of the present utility model, a terminal assembly is further arranged at the outer bottom of the base; the terminal assembly comprises a first terminal, a second terminal, and a third terminal arranged between the first terminal and the second terminal; the first terminal is connected to a side contact bubble point; the second terminal is connected to the non-silent contact block; and the middle contact bubble point, the first connecting post, and the second connecting post are all connected to the third terminal.

As a further improvement of the present utility model, a first upper through hole for an upper end of the guide core to extend from the housing and a second upper through hole for the second upper action protrusion to extend from the housing are respectively arranged on the upper cover; an upper inner groove for cooperating with the pressing piece is arranged in the upper cover and located at the outer periphery of the second upper through hole; and the transverse arm and the action block of the pressing piece are clamped into the upper inner groove.

As a further improvement of the present utility model, a fixing groove is concavely formed at the lower end of the guide core; and the first upper action protrusion is clamped into the fixing groove.

As a further improvement of the present utility model, at least one action arm respectively acting on the silent module and the non-silent module is formed on a side edge of the guide core; the lower end of the guide core extends downwards to form a rotary shaft, and a switching piece is arranged on the guide core to drive the guide core to rotate and extend from the housing; the end portion of the action arm is bulged downwards to form an action block; the switching piece comprises a positioning connecting block, and a handle connected to the positioning connecting block and extending from the housing, wherein a square hole is formed on the positioning connecting block, and a square block is arranged on the guide core, the square block being clamped into the square hole; two arc-shaped concave fixing slots are arranged on the outer side of the positioning connecting block; a positioning elastic sheet is arranged in the housing and close to the side edge of the positioning connecting block; an arc-shaped convex fixing portion cooperating with the arc-shaped concave fixing slots is formed on the positioning elastic sheet; and the number of action arms is two, comprising a silent action arm acting on the silent module and a non-silent action arm acting on the non-silent module, respectively.

As a further improvement of the present utility model, two opposing guide posts are arranged on the base and at both sides between the first connecting post and the second connecting post; a guide slot is respectively formed on opposing side surfaces of the two guide posts; a first limiting post is respectively arranged on the base and at both sides of the non-silent contact block; the reed is limited in a space surrounded by the two guide posts and two first limiting posts; two ends of the transverse arm are inserted into the guide slot and move up and down along the guide slot; and a second limiting post is respectively arranged on the base and close to two opposite sides of one end of the cavity.

As a further improvement of the present utility model, a cover plate is arranged in the housing and above the silent module and the non-silent module; a first avoidance hole for embedding the first upper action protrusion, a second avoidance hole for embedding the second upper action protrusion, and a third avoidance hole for inserting the rotary shaft are respectively arranged on the cover plate; fixing holes for inserting the upper ends of the first limiting posts and the second limiting posts are respectively arranged at both ends of the cover plate; a positioning groove is formed on the bottom surface of the cover plate by being concaved inwards at the outer periphery of the second avoidance hole; a positioning boss is formed in the positioning groove by protruding downwards at the outer periphery of the second avoidance hole; a transverse groove for embedding the transverse arm is formed on the positioning boss; the upper ends of the two guide posts are respectively clamped into both ends of the positioning groove; an inner support post and an outer support post are respectively arranged on the cover plate and located on two side surfaces of the third avoidance hole; the upper end of the inner support post extends above the cover plate and has an upper convex fixing block; the upper end of the outer support post extends above the cover plate and contacts with the lower end surface of the handle; the outer side surface of the outer support post is embedded in the housing; the rotary shaft is inserted into the third avoidance hole; the positioning elastic sheet is arranged between the inner side wall of the housing and the upper convex fixing block; and a first avoidance slot cooperating with the first silent action arm and a second avoidance slot cooperating with the non-silent action arm are respectively arranged on the cover plate at two sides between the third avoidance hole and the inner support post.

A mouse comprises the switch as described above.

A keyboard comprises the switch as described above.

According to the beneficial effects of the utility model, the silent module inside the switch of the present utility model are a silencing elastic sheet with a special structure and a silencing rubber pad. When the switch is pressed, it may achieve a near-silent effect and also has an excellent hand feeling. The silent module may be combined with the non-silent module and centrally arranged in the housing to constitute a non-silent and silent switch one-piece switch and extend the function of the switch. By further using the improved guide core in the one-piece switch and arranging a switching piece on the guide core, the one-piece switch may be easily switched between non-silent and silent states. It has a simple structure and easy to use, and may be applied to buttons of the mouse and the keyboard.

The above mentioned is an overview of the technical solution of the utility model. A further explanation of the utility model is given below in combination with the attached drawings and detailed description.

### BRIEF DESCRIPTION OF THE DRAWINGS

FIG. 1 is an explosive view of a switch in Example 1 of the present utility model;

FIG. 2 is a structural schematic view of a silencing elastic sheet in a switch of the present utility model;

FIG. 3 is a structurally schematic view of a silencing rubber pad in a switch of the present utility model;

FIG. 4 is a structurally schematic view of a guide core in Examples 1 and 2 of the present utility model;

FIG. 5 is a structurally schematic view of a base in Example 1 of the present utility model;

FIG. 6 is a structurally schematic view of a reed of the present utility model;

FIG. 7 is an explosive view of a switch in Example 1 of the present utility model;

FIG. 8 is a structurally schematic view of a terminal assembly in Examples 2 and 3 of the present utility model;

FIG. 9 is a structurally schematic view of a pressing piece in Example 2 of the present utility model;

FIG. 10 is a structurally schematic view of an upper cover in Example 2 of the present utility model;

FIG. 11 is an explosive view of a switch in Example 3 of the present utility model;

FIG. 12 is a structurally schematic view of a guide core in Example 3 of the present utility model;

FIG. 13 is a structurally schematic view of a switching piece in Example 3 of the present utility model;

FIG. 14 is a structurally schematic view in which the guide core is connected to the switching piece of Example 3 of the present utility model;

FIG. 15 is a structurally schematic view of a pressing piece in Example 3 of the present utility model;

FIG. 16 is a structurally schematic view of a positioning elastic sheet in Example 3 of the present utility model;

FIG. 17 is a schematic view of an internal structure of a switch in Example 3 of the present utility model;

FIG. 18 is a structurally schematic view of a base in Example 3 of the present utility model;

FIG. 19 is a structurally schematic view of a cover plate in Example 3 of the present utility model;

FIG. 20 is a structurally schematic view of a lower end face of the cover plate in Example 3 of the present utility model;

### DETAILED DESCRIPTION

In order to further explain the technical means and effects of the present utility model for achieving the intended purpose, the following detailed description of the examples of the present utility model will be made with reference to the accompanying drawings and preferred examples.

### EXAMPLE 1

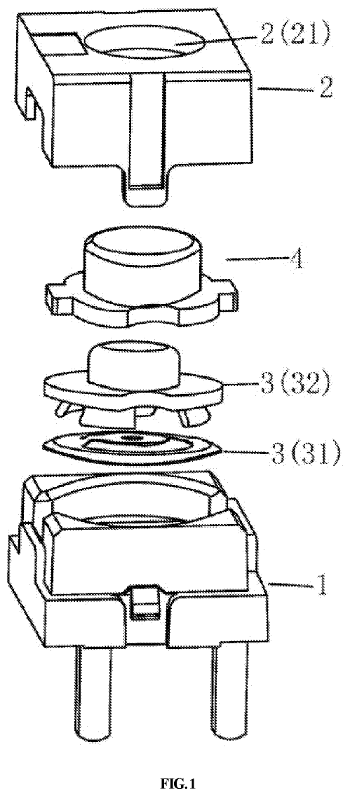

With reference to FIGS. 1 and 2, the example of the present utility model provides a switch, including a housing, a silent module 3 arranged in the housing, and a guide core 4 arranged in the housing above the silent module 3 and extending from the housing. The silent module 3 includes a silencing elastic sheet 31 arranged in the housing, and a silencing rubber pad 32 arranged in the housing above the silencing elastic sheet 31; the silencing elastic sheet 31 is upwardly arched at a central position thereof to form an upper arched portion 311; a through hole 312 is formed on the upper arched portion 311; an action sheet 313 is arranged on the silencing elastic sheet 31 at the through hole 312; and the action sheet 313 is connected to the silencing elastic sheet 31 via at least one connecting arm 314. When the guide core 4 is pressed, the guide core 4 drives the silencing rubber pad 32 to move downwards synchronously and act on the action sheet 313 of the silencing elastic sheet 31. At this moment, only the connecting arm 314 connected to the action sheet 313 deforms along with the movement of the action sheet 313 on the whole silencing elastic sheet 31, and the overall deformation of the silencing elastic sheet 31 is small. After stopping pressing the guide core 4, the guide core 4 moves upwards, and the force acting on the action sheet 313 is eliminated. The action sheet 313 moves upwards and resets under the elastic restoring force of the connecting arm 314. Since the overall deformation of the silencing elastic sheet 31 is small, the action sheet 313 is reset upwards with a relatively low speed and a lower potential energy, and the action surface of the action sheet 313 hitting the silencing rubber pad 32 is relatively small, the action sheet 313 hitting the lower end of the silencing rubber pad 32 with a small rebound force emits a sound which is hardly audible to the human ear, so as to achieve a near-silent effect.

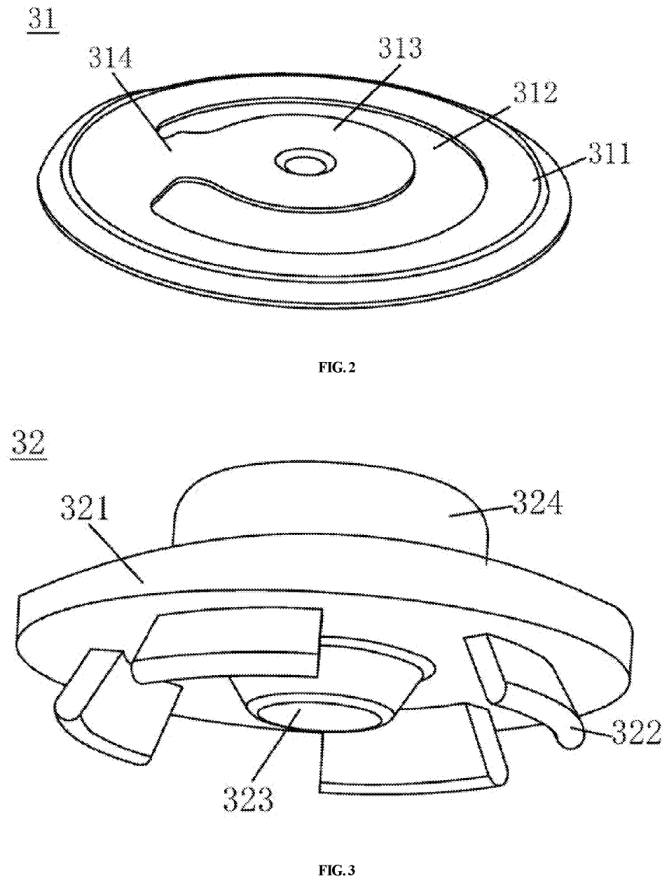

As shown in FIG. 3, in order to further reduce the sound of switch pressing so as to achieve a near-silent effect and improve the press hand feeling, in the present example, a silencing rubber pad 32 with a special structure is used. The silencing rubber pad 32 includes a middle limiting block 321 and a plurality of arc-shaped support sheets 322 which are annularly arranged at a lower end of the middle limiting block 321 and are uniformly distributed, the support sheets 322 having the same circle center and being located on the same cylindrical curved surface. When pressing the guide core 4 to push the silencing rubber pad 32 to move downwards synchronously, since a support sheet 322 is arranged at the lower end of the middle limiting block 321, a certain pressing force is required to push the support sheet 322 to deform and move downwards. At the same time, since each support sheet 322 is an independent and non-connected structure, the support sheet 322 will deform and move downwards without requiring too much pressing force. The pressing is convenient and it has a better press hand feeling. After the pressing of the guide core 4 is stopped, the deformed support sheet 322 rapidly resets and moves upwards to generate a larger potential energy, while the silencing elastic sheet 31 has a smaller deformation amount due to the deformation of only the connecting arm 314. The speed of upward reset is small, and thus the potential energy is also small. Thus, the silencing rubber pad 32 provides an elastic force for upward reset and pushes the guide core 4 to reset. The sound of the silencing rubber pad 32 hitting the guide core 4 is smaller than the sound of the action sheet 313 of the silencing elastic sheet 31 hitting the silencing rubber pad 32. The sound generated at the time of resetting is smaller, close to silence.

Specifically, the lower end of the support sheet 322 is inclined outwardly and contacts an edge of the upper surface of the silencing elastic sheet 31. That is, the support sheets 322 are all located on the same truncated-cone-shaped surface. When the support sheets 322 are subjected to a downward pressure, the support sheets 322 are more likely to deform and move downwards, thereby improving the smoothness of the switch pressing operation while ensuring the switch press hand feeling.

Specifically, the height of the action sheet 313 is higher than the height of the upper end of the silencing elastic sheet 31. A lower action protrusion 323 is arranged at a lower end of the middle limiting block 321 and located above the action sheet 313. The support sheet 322 is annularly arranged at the periphery of the lower action protrusion 323, so that the lower action protrusion 323 of the silencing rubber pad 32 may accurately act on the action sheet 313 and only push the action sheet 313 downwards. At this time, only the connecting arm 314 of the silencing elastic sheet 31 is deformed without other deformation. After each pressing, the silencing elastic sheet 31 has a small deformation potential energy, and hits the silencing rubber pad 32 with a small force, so as to achieve a near silent effect.

Specifically, in the present example, the shape of the lower action protrusion 323 is a cone frustum. The diameter of the lower end of the lower action protrusion 323 is greater than the diameter of the upper end thereof, thereby stably pushing the action sheet 313 downwards.

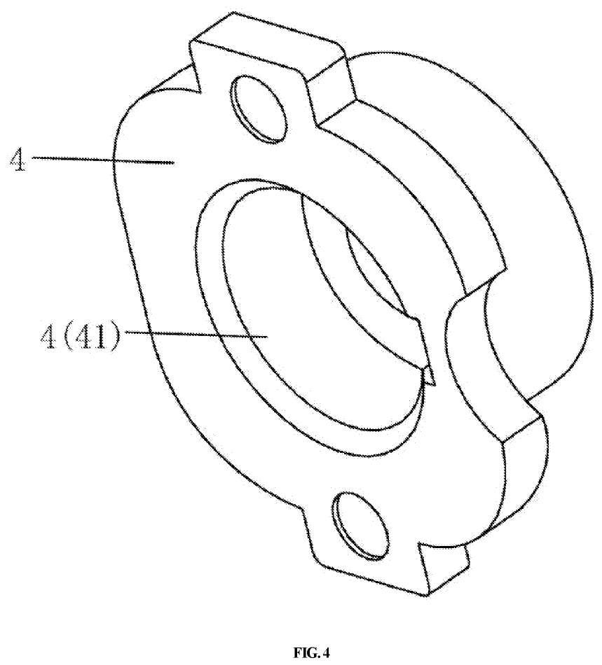

In the present example, as shown in FIGS. 3 and 4, an upper action protrusion 324 is further formed on an upper end surface of the middle limiting block 321. A fixing groove 41 is concavely formed at a lower end of the guide core 4. The first upper action protrusion 324 is clamped into the fixing groove 41 to improve the stability of the guide core 4 acting on the silencing rubber pad 32, thereby improving the stability of the switch.

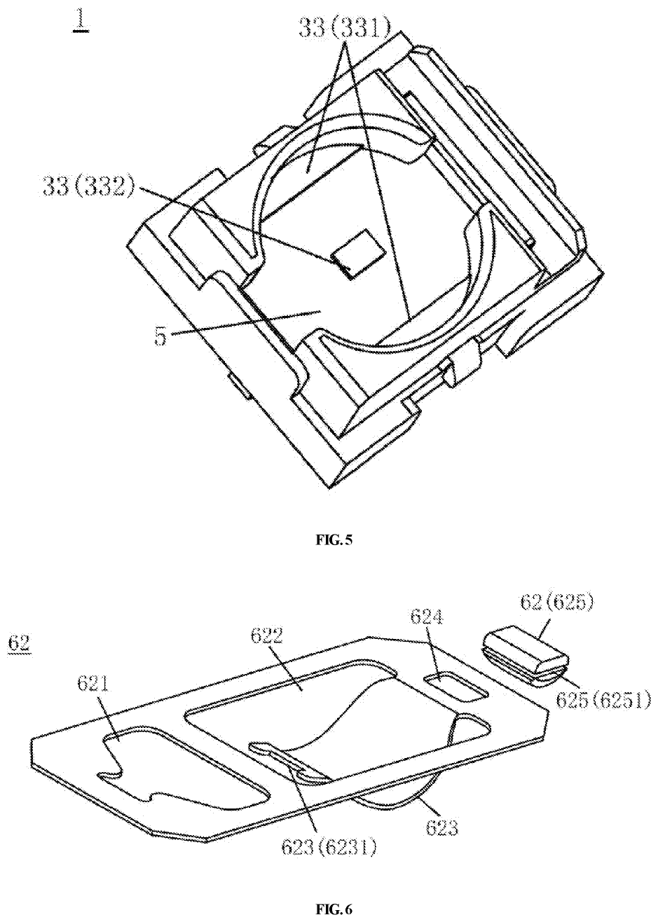

In the present example, as shown in FIGS. 1 and 5, the housing includes a base 1, and an upper cover 2 arranged above the base 1. A first through hole 21 is formed on the upper cover 2 for the upper end of the guide core 4 to extend from the housing. A cavity 5 for accommodating the silent module 3 is formed on the base 1. The silent module 3 further includes a contact bubble point module 33 arranged in the cavity 5 and located below the silencing elastic sheet 31. The contact bubble point module 33 includes two side contact bubble points 331 arranged in the cavity 5 and located at both sides below the silencing elastic sheet 31. A middle contact bubble point 332 arranged in the cavity 5 below the action sheet 313 and located between the two side contact bubble points 331. The lower surface of the silencing elastic sheet 31 contacts with the two side contact bubble points 331. When pressing the guide core 4 to push the action sheet 313 down to contact the middle contact bubble point 331, since the action sheet 313 is connected to the silencing elastic sheet 31 via the connecting arm 314, the side contact bubble point 331 is connected to the middle contact bubble point 332 to realize switch conduction. Meanwhile, the pressing also has a hand feeling and can achieve a near-silent effect.

### EXAMPLE 2

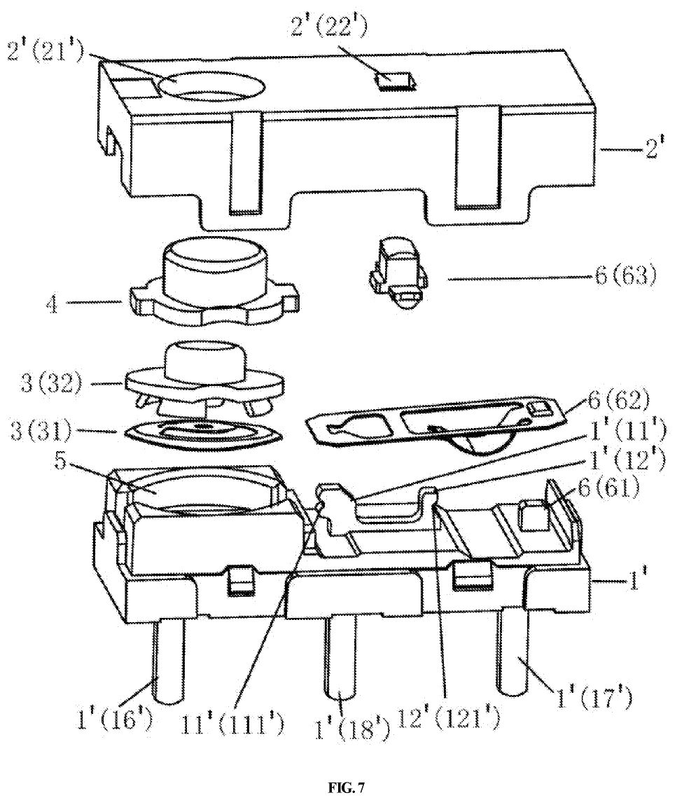

As shown in FIG. 7, Example 2 differs from Example 1 mainly in that the housing includes a base 1′, and an upper cover 2′ arranged above the base. A non-silent module 6 is arranged inside the housing and outside the cavity 5. The non-silent module 6 includes a non-silent contact block 61 formed on the base 1′, a reed 62 arranged on the base 1′ and above the non-silent contact block 61, and a pressing piece 63 movably arranged in the housing and above the reed 62. By arranging the non-silent module 6 and the silent module 3 centrally in the housing, a non-silent and silent combination switch is obtained, so that the switch has both non-silent and silent functions.

Specifically, a first connecting post 11′ and a second connecting post 12′ are respectively formed inside the housing and outside the cavity 5. A first clamping groove 111′ is formed outside the first connecting post 11′. A second clamping groove 121′ is formed outside the second connecting post 12′. As shown in FIG. 6, a first opening 621 through which the first connecting post 11′ passes and a second opening 622 through which the second connecting post 12′ passes are respectively formed on the reed 62. An inner wall of the first opening 621 is clamped and connected to the first clamping groove 111′. An elastic connecting arm 623 bent downwards is formed on a side wall of the second opening 622. An end portion of the elastic connecting arm 623 extends into the second opening 622 and is formed with an opening 6231 cooperating with the second clamping groove 121′, the opening 6231 being clamped and connected to the second clamping groove 121′. As shown in FIG. 9, the pressing piece 63 includes a transverse arm 631 above which a second upper action projection 632 is formed. The lower end face of the transverse arm 631 is bulged downwards to form a curved structure and acts on the reed 62. A clamping block 633 is bulged outwards on both sides of the transverse arm 631, respectively. Since one end of the reed 62 is fixedly connected to the first connecting post 11′, an end portion of the elastic connecting arm 623 of the reed 62 is fixedly connected to the second connecting post 12′, and one end of the reed 62 located above the non-silent contact block 61 is a movable end. The reed 62 moves downwards by pressing the pressing piece 63, and the movable end of the reed 62 moves downwards to contact the non-silent contact block 61, so as to realize switch conduction. At this moment, the elastic connecting arm 623 deforms. After releasing the pressing force on the pressing piece 63, under the action of the elastic restoring force, the elastic connecting arm 623 drives the reed 62 to move upwards and pushes the pressing piece 63 to move upwards and reset. Then, the movable end of the reed 62 moves upwards and downwards using the second connecting post 12′ as a supporting point and repeatedly hits the inner wall of the contact block 61 and the upper cover 2′ to generate a crisp sound, so as to achieve the effect of emitting a sound by pressing the switch.

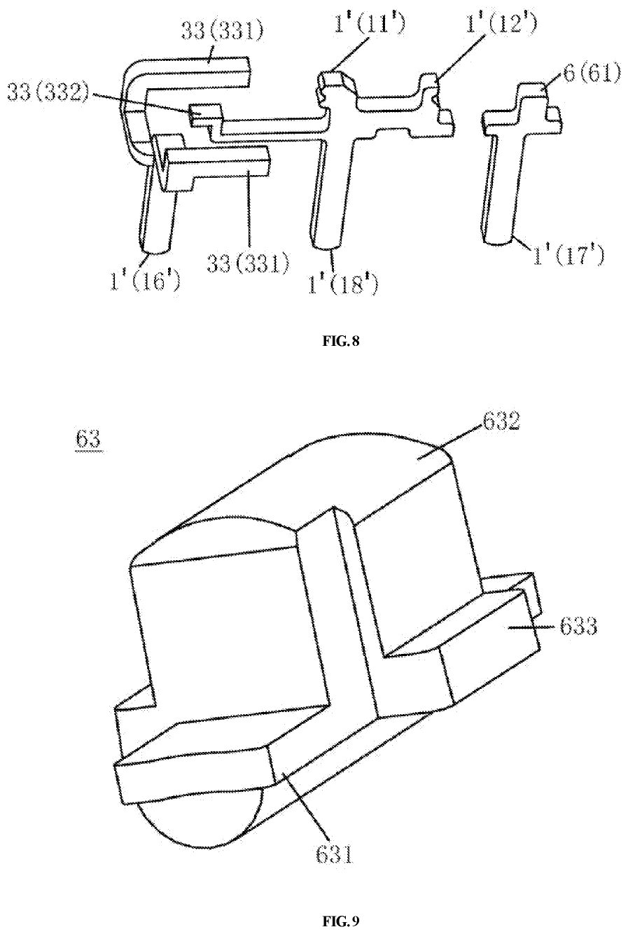

Specifically, as shown in FIGS. 7 and 8, a terminal assembly is further arranged at the outer bottom of the base 1′. The terminal assembly includes a first terminal 16′, a second terminal 17 ‘and a third terminal 18’ arranged between the first terminal 16′ and the second terminal 17′. The first terminal 16′ is connected to a side contact bubble point 331. The second terminal 17′ is connected to the non-silent contact block 61. The middle contact bubble point 332, the first connecting post 11′ and the second connecting post 12′ are all connected to the third terminal 18′. When in use, the switch is connected into the circuit via the terminal assembly. When the action sheet 311 of the silencing elastic sheet 31 moves down to contact the middle contact bubble point 332, the middle contact bubble point 332 is connected to the side contact bubble point 331. The first terminal 16′ is conductive with the third terminal 18′, namely, the silent module 3 is conductive. When the pressing piece 63 is pressed, the movable end of the reed 62 is pushed down and comes into contact with the non-silent contact block 61. At this time, the non-silent contact block 61 comes is connected to the first connecting post 11′, the second terminal 17′ is conductive with the third terminal 18′, i.e., the non-silent module 6 is conductive.

Specifically, as shown in FIG. 6, in order to further improve the non-silent effect of the non-silent module 6, a third opening 624 is further arranged on the reed 62 and above the non-silent contact block 61. A non-silent action block 625 is arranged on the third opening 624. Specifically, the non-silent action block is made of a metal material. An annular groove 6251 is arranged on the outer periphery of the side surface of the non-silent action block 625. The inner side wall of the third opening 624 is clamped into the annular groove 6251. When the reed 62 springs up and down, the non-silent action block 625 directly hits the inner side of the upper cover 2′ and the non-silent contact block 61. The sound emitted is more crisp, and the non-silent effect of the non-silent module is further improved.

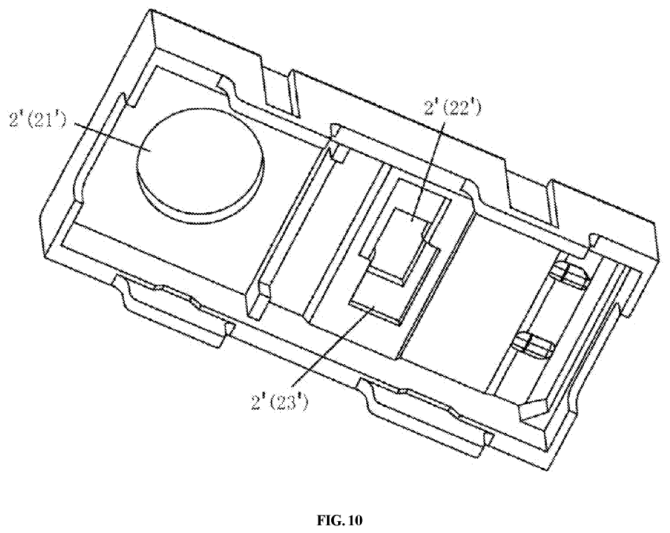

Specifically, as shown in FIGS. 7 and 10, a first upper through hole 21′ for an upper end of the guide core to extend from the housing and a second upper through hole 22′ for the second upper action protrusion 632 to extend from the housing are respectively arranged on the upper cover 2′. An upper inner groove 23′ for cooperating with the pressing piece 63 is arranged in the upper cover 2′ and located at the outer periphery of the second upper through hole 22′. The transverse arm 631 and the action block 632 of the pressing piece 63 are clamped into the upper inner groove 23′, so that the pressing piece 63 moves up and down along the second upper through hole 22′ and the upper inner groove 23′, providing a stabilizing action on the sound assembly 6 and improving the stability of the switch.

### EXAMPLE 3

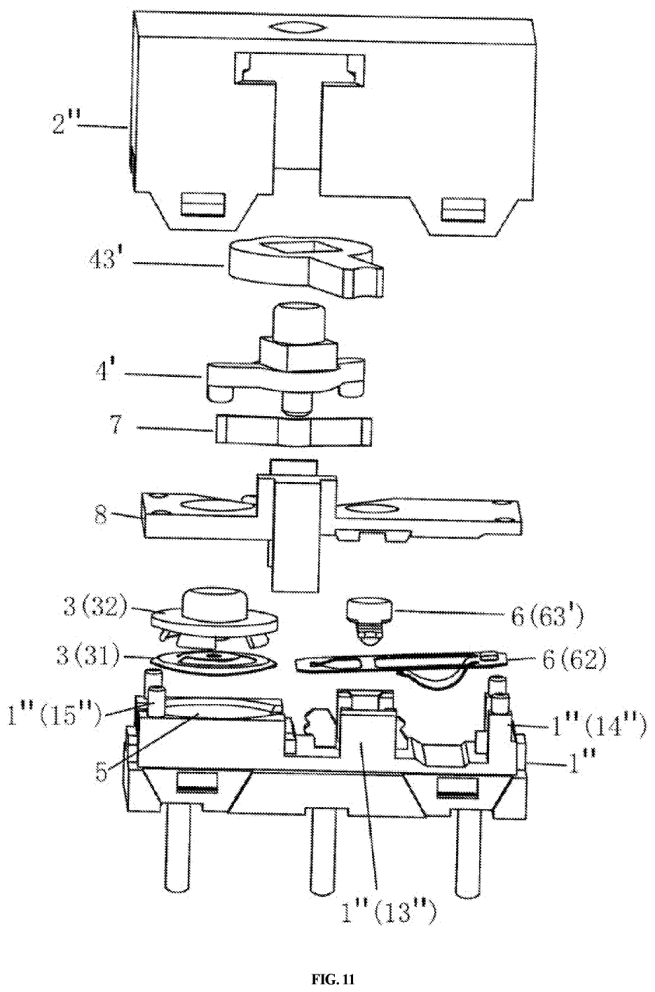

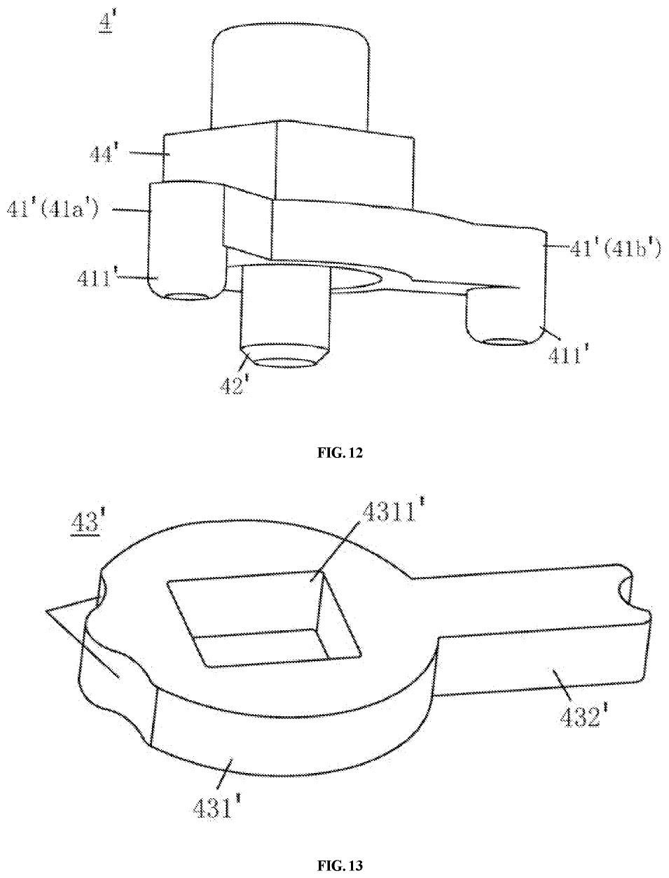

As shown in FIGS. 11 to 14, Example 3 differs from Example 2 mainly in that the housing includes a base 1″ and an upper cover 2″ arranged above the base 1″. At least one action arm 41′ (41a′, 41b′) respectively acting on the silent module 3 and the non-silent module 6 is formed on a side edge of the guide core 4′. The lower end of the guide core 4′ extends downwards to form a rotary shaft 42′. A switching piece 43′ is provided on the guide core 4′ to drive the guide core 4′ to rotate and extend from the base 1″. By driving the switching piece 43′ to rotate the guide core 4′, the action arms 41′ (41a′, 41b′) on the guide core 4′ rotate synchronously and switch between the silent module 3 and the non-silent module 6, so as to switch the switch between the non-silent and silent states.

Specifically, the end portion of the action arm 41′ (41a′, 41b′) protrudes downwards to form an action block 411′. When pressing the guide core 4′ to drive the action arm 41′ (41a′, 41b ‘) to move downwards, the action block 411’ on the action arm 41′ (41a′, 41b′) acts on the silent module 3 or the non-silent module 6, so as to better push the silent module 3 and the non-silent module 6 to move downwards.

Specifically, the number of the action arms 41′ (41a′, 41b′) is two, and respectively includes a silent action arm 41a′ acting on the silent module 3 and a non-silent action arm 41b′ acting on the sound generation assembly 6. By rationally setting the positions of the silent action arm 41a′ and the non-silent action arm 41b′, when the guide core 4′ is rotated, the silent action arm 41a′ is rotated above the silent module 3, the non-silent action arm 41b′ is synchronously rotated away from above the sound generation assembly 6. When the guide core 4′ is pressed, the silent action arm 41a′ acts on the silent module 3, and the switch is in a silent state. The guide core 4′ is rotated again so that the non-silent action arm 41b′ rotates above the non-silent module 6. At this moment, the silent action arm 41a′ rotates synchronously away from above the silent module 3. When the guide core 4′ is pressed, the non-silent action arm 41b′ acts on the non-silent module 6, and the switch is in a non-silent state.

Specifically, the switch 43′ includes a positioning connecting block 431′, and a handle 432′ connected to the positioning connecting block 431′ and extending from the housing. A square hole 4311′ is formed on the positioning connecting block 431′. A square block 44 ‘is provided on the guide core 4’, and the square block 44′ is clamped into the square hole 4311′. When driving the switching piece 43′ to rotate the guide core 4′, no relative movement occurs between the guide core 4′ and the switch 43′, thereby improving the accuracy of the position switching of the guide core 4′ between the non-silent module 6 and the silent module 3.

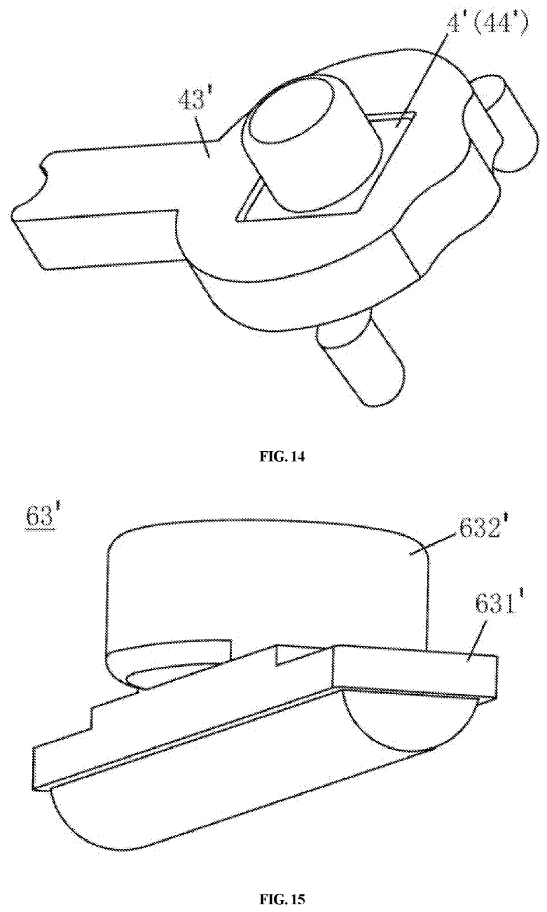

Specifically, as shown in FIGS. 14, 16 and 17, two arc-shaped concave fixing slots 4312′ are arranged on the outer side of the positioning connecting block 431′. A positioning elastic sheet 7 is arranged in the housing and close to the side edge of the positioning connecting block 431′. An arc-shaped convex fixing portion 71 cooperating with the arc-shaped concave fixing slots 4312′ is formed on the positioning elastic sheet 7. When driving the switching piece 43′ to rotate the guide core 4′, the positioning connecting block 431′ rotates synchronously and presses the positioning elastic sheet 7 to deform, and the positioning connecting block 431′ continues to rotate until the arc-shaped convex fixing portion 71 is clamped into one of the arc-shaped concave fixing slots 4312′. The guide core 4′ rotates into position. At this time, the silent action arm 41a′ is positioned above the silencing module 3, and the switch is in a silent state. By the same reasoning, the switching piece 43′ is driven to rotate the positioning connecting block 431′, so that the arc-shaped convex fixing portion 71 is clamped into another arc-shaped concave fixing slot 4312′ of the positioning connecting block 431′. At this moment, the non-silent action arm 41b′ is located above the non-silent module 6, and the switch is in a non-silent state. By means of the cooperation between the arc-shaped convex fixing portion 71 and the arc-shaped concave groove 4312′, accurate switching of the guide core 4′ between the non-silent module 6 and the silent module 3 is facilitated, so as to improve the stability of the switch.

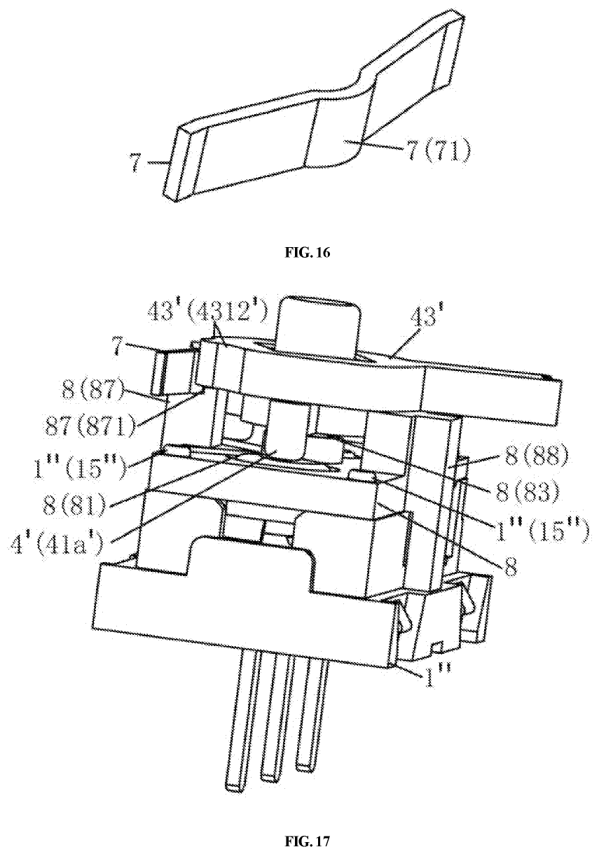

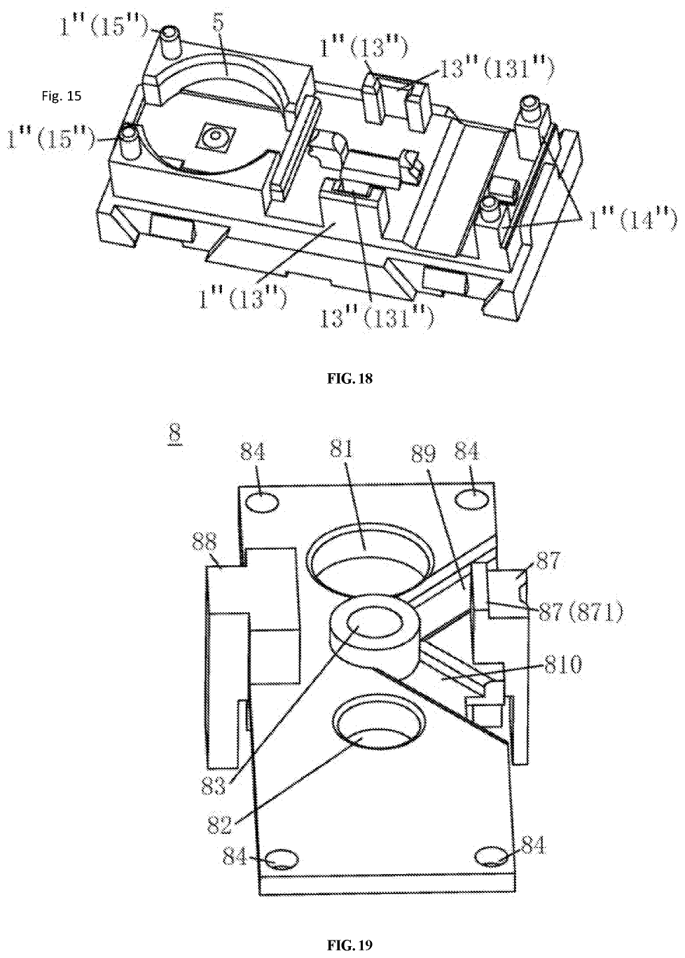

Specifically, as shown in FIG. 15, the pressing piece 63′ includes a transverse arm 631′ above which a second upper action projection 632′ is formed. The lower end of the transverse arm 631′ protrudes downwards to form a curved structure and acts on the reed 62.

Specifically, as shown in FIG. 18, in order to improve the stability of the non-silent module 6, two opposite guide posts 13″ are arranged on the base 1″ and located at both sides between the first connecting post 11 and the second connecting post 12. A guide slot 131″ is respectively formed on the opposite sides of the two guide posts 13″. Opposite first limiting posts 14″ are respectively arranged on the base 1″ and located at both sides of the non-silent contact block 61. The reed 62 is limited in a space enclosed by the two guide posts 13″ and the two first limiting posts 14″. Both ends of the transverse arm 631′ are inserted into the guide slot 131″ and move up and down along the guide slot 131″.

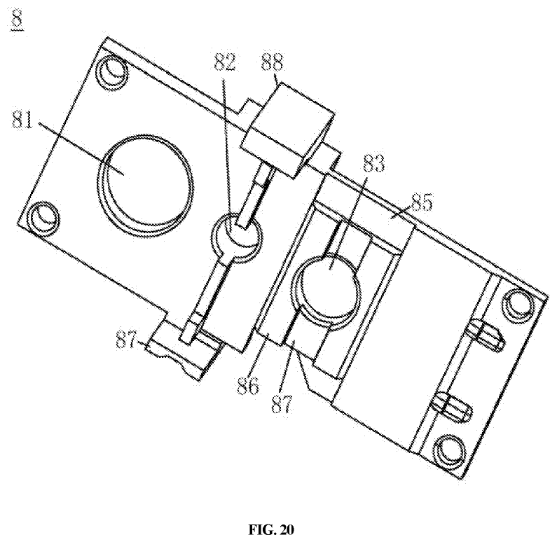

As shown in FIGS. 17, 18 and 19, in order to improve the stability of the whole switch function, a second limiting post 15″ is respectively arranged on two opposite sides of the base 1″ and close to one end of the cavity 5. A cover plate 8 is arranged in the housing and located above the silent module 3 and the non-silent module 6. A first avoidance hole 81 for embedding the first upper protrusion 324, a second avoidance hole 82 for embedding the second upper action protrusion 632, and a third avoidance hole 83 for inserting the rotary shaft are respectively arranged on the cover plate 8. Fixing holes 84 for inserting the upper ends of the first limiting posts 14″ and the second limiting posts 15″ are respectively arranged at both ends of the cover plate 8. By providing a cover plate 8 in the accommodating cavity, the silent module 3 is limited in the space enclosed by the cavity 5 and the cover plate 8. The non-silent module 6 is limited in a space enclosed by the guide post 13, the first limiting post 14 and the cover plate 8. When the guide core 4′ is pressed, each moving component may stably and accurately cooperate, improving the stability of the whole switch function.

A positioning groove 85 is formed on the bottom surface of the cover plate 8 by being concaved inwards at the outer periphery of the second avoidance hole 82. A positioning boss 86 is formed in the positioning groove 85 by protruding downwards at the outer periphery of the second avoidance hole 83. A transverse groove 861 for embedding the transverse arm 631′ is formed on the positioning boss 86. The upper ends of the two guide posts 13″ are respectively clamped into the both ends of the positioning groove 85.

An inner support post 87 and an outer support post 88 are respectively arranged on the cover plate 8 and located on two side surfaces of the third avoidance hole 83. The upper end of the inner support post 87 extends above the cover plate 8 and has an upper convex fixing block 871. The upper end of the outer support post 88 extends above the cover plate 8 and contacts with the lower end surface of the handle 432′. The outer side surface of the outer support post 88 is embedded in the housing. The rotary shaft 42′ is inserted into the third avoidance hole 83. The positioning elastic sheet 7 is arranged between the inner side wall of the housing and the upper convex fixing block 871. A first avoidance slot 89 cooperating with the first silent action arm 41a′ and a second avoidance slot 810 cooperating with the non-silent action arm 41b′ are respectively arranged on both sides of the cover plate 8 between the third avoidance hole 83 and the inner support post 87 to further improve the stability of the switch for switching between non-silent and silent states.

In summary, in the switch of the present utility model, the silent module inside the switch of the present utility model are a silencing elastic sheet 31 with a special structure and a silencing rubber pad 32. When the switch is pressed, the switch may achieve a near-silent effect and also have an excellent hand feeling. The silent module 3 may be combined with the non-silent module 6 and centrally arranged in the housing to constitute a non-silent and silent switch one-piece switch and extend the function of the switch. By further using the improved guide core 4′ in the one-piece switch and arranging a switching piece 43′ on the guide core 4′, the one-piece switch may be easily switched between non-silent and silent states. It has a simple structure and is easy to use, and may be applied to buttons of the mouse and the keyboard.

In the description above, only the preferred examples of the utility model has been described, and the technical scope of the utility model is not limited in any way. Therefore, other structures obtained by adopting the same or similar technical features as those of the above examples of the utility model are within the scope of the utility model.

What is claimed is:

1. A switch comprising a housing, a silent module arranged in the housing, and a guide core arranged in the housing above the silent module and extending from the housing, wherein the silent module comprises a silencing elastic sheet arranged in the housing, and a silencing rubber pad arranged in the housing above the silencing elastic sheet; the silencing elastic sheet is upwardly arched at a central position thereof to form an upper arched portion; a through hole is formed on the upper arched portion; an action sheet is arranged on the silencing elastic sheet at the through hole; and the action sheet is connected to the silencing elastic sheet via at least one connecting arm.

2. The switch according to claim 1, wherein the silencing rubber pad comprises a middle limiting block, and a plurality of arc-shaped support sheets which are annularly arranged at a lower end of the middle limiting block and uniformly distributed, the support sheets having the same circle center and being located on the same cylindrical curved surface.

3. The switch according to claim 2, wherein a height of the action sheet is higher than a height of an upper end of the silencing elastic sheet.

4. The switch according to claim 3, wherein a lower action protrusion is arranged on a lower end surface of the middle limiting block and above the action sheet; and the support sheet is arranged around the periphery of the lower action protrusion.

5. The switch according to claim 4, wherein the shape of the lower action protrusion is a cone frustum; and the diameter of the lower end of the lower action protrusion is greater than the diameter of the upper end thereof.

6. The switch according to claim 2, wherein the lower end of the support sheet is inclined outwardly and contacts an edge of the upper surface of the silencing elastic sheet.

7. The switch according to claim 1, wherein the housing comprises a base, and an upper cover arranged above the base; a first through hole is formed on the upper cover for the upper end of the guide core to extend from the housing; a cavity for accommodating the silent module is formed on the base; the silent module further comprises a contact bubble point module arranged in the cavity and located below the silencing elastic sheet, wherein the contact bubble point module comprises two side contact bubble points arranged in the cavity and located at both sides below the silencing elastic sheet, and a middle contact bubble point arranged in the cavity below the action sheet and located between the two side contact bubble points; and the lower surface of the silencing elastic sheet contacts with the two side contact bubble points.

8. A mouse comprising a switch according to claim 1.

9. A keyboard comprising a switch according to claim 1.
